(19) United States
(12) Patent Application Publication
(10) Pub. No.: US 2006/0007251 A1
(43) Pub. Date: Jan. 12, 2006

(54) Display apparatus and control method thereof

(75) Inventors: Soo-ho Park, Suwon-si (KR); Hwa-seok Seong, Suwon-si (KR); Nam-cho Jo, Suwon-si (KR); Sung-goo Lee, Suwon-si (KR); Gwon-jin Moon, Chilgok-gun (KR); Chul-ho Son, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/144,755

(22) Filed: Jun. 6, 2005

(30) Foreign Application Priority Data
Jun. 4, 2004 (KR) 2004-40987

(51) Int. Cl. G09G 5/10

(52) U.S. Cl. 345/690

(57) ABSTRACT

A display apparatus processing an image frame divided into a plurality of subfields based on time, includes a motion detector detecting whether an input image is a still picture; a gradation level converter converting a brightness level of the input image into one of the gradation levels among a predetermined gradation level group for a still picture if the motion detector detects no motion in the input image, the gradation level group for the still picture formed with gradation levels having no more than a predetermined reference number of subfields which are different in a state of luminance with respect to the corresponding subfields in adjacent gradation levels. With this configuration, the present invention provides a display apparatus and a control method thereof to prevent brightness represented by gradation levels from being displayed inaccurately due to the load of a display line.

### CROSS-REFERENCE TO RELATED APPLICATIONS

This application claims the benefit of Korean Patent Application No. 2004-40987, filed on Jun. 4, 2004, in the Korean Intellectual Property Office, the disclosure of which is incorporated herein by reference.

### BACKGROUND OF THE INVENTION

1. Field of the Invention

The present invention relates to a display apparatus and a controlling method thereof and, more particularly, to a display apparatus and a controlling method thereof representing gradations by employing a time-division method.

2. Description of the Related Art

According to a time-division method, an image frame is divided into a plurality of subfields to which a given luminance time is respectively weighted, and each of the subfields controls the luminance state of each pixel in order to display a gradation level corresponding to the respective pixels. A plasma display panel (PDP) and a digital mirror device (DMD) employ this time-division method.

FIG. 1 shows a time configuration of a frame and subfields of the PDP. As shown therein, a single frame is divided into eight subfields (SF1, SF2, SF3, SF4, SF5, SF6, SF7, SF8), and the number of sustain pulses weighted to the subfields SF1 through SF8 are 1, 2, 4, 8, 16, 32, 64, 128, respectively. The sustain pulse is a common signal inputted to an array of pixels, and the number of sustain pulses weighted to each of the subfields is proportional to the luminance time.

Thus, for example, if a pixel of the PDP is expected to sustain the luminance state for a time period which is proportional to 129 sustain pulses per frame, two subfields among the eight subfields are selected to be emitted, the two subfields being the leftmost subfield (SF1) and the rightmost subfield (SF8).

The eight subfields are represented by a subfield codeword which indicates whether the respective subfields per frame are in the luminescence state. The subfield codeword is a sequential array of 8-bit binary data with each bit representing one of the subfields, and thus, the eight subfields in the above example can be represented as [10000001]. The binary number “1” indicates that the corresponding subfield is in the luminescence state whereas “0” indicates that the corresponding subfield is not in the luminescence state.

Meanwhile, each of the subfields includes a reset time, an address time and a sustain time. At the reset period, each of pixels in the PDP is initialized with respect to the luminescence state. At the address period, the pixel is selected to emit light. At the sustaining period, the pixel selected during the address period is allowed to sustain its luminescence state. The sustain pulse is outputted in accordance with a weighted value of each subfield. The period of the luminescence state is increased in proportion to the number of sustain pulses transmitted to the PDP during the sustaining period.

As previously described, the sustain pulse is a common signal transmitted to the corresponding pixels. Generally, the sustain pulse is inputted to linearly arranged pixels forming a panel.

FIG. 2A illustrates a distribution of gradation levels per line used for explaining a load variation of the sustain pulse corresponding to the distribution of the gradation levels, and FIG. 2B illustrates the subfield codeword representing the respective subfields.

According to the image data, a majority of the pixels in a first line in FIG. 2A is expressed by gradation level [159], and a minority of the pixels in a second line is expressed by gradation level [160]. Referring FIG. 2B, the first subfield SF1 through the fifth subfield SF5 of gradation level [159] are in the luminance state, whereas the sixth subfield SF6 is not in the luminance state. On the other hand, the first through the fifth subfields of the gradation level [160] are not in the luminance state and the sixth subfield is in the luminance state.

Hence, in the first line, most of the pixels emit light during the sustaining periods corresponding to the first through fifth subfields, and relatively few pixels emit light during the sustaining period of the sixth subfield. In other words, the number of pixels emitting light is greater in the first through fifth subfields than in the sixth subfield. Thus, the load of the sustain pulse driving the first line becomes heavy. Accordingly, the quantity of light emitted from each pixel decreases in proportion to the load of the sustain pulse which increases in proportion to the number of pixels. Meanwhile, the amount of the light emitted from the pixels in the sixth subfield is relatively increased.

Gradation level [159] differs from gradation level [160] by one gradation level. Thus, a viewer looking at the screen should hardly notice the gradation level difference since the gradation level difference between the adjacent gradation levels is 1. However, these two adjacent gradation levels show a great difference in brightness and the viewer may see an apparent borderline between the gradation levels while looking at the screen because of the difference in brightness between the adjacent gradation levels.

Referring to the second line in FIG. 2A, most of the pixels are expressed by gradation level [160], and thus, the load of the sustain pulse in the sixth subfield driving the second line is increased. Accordingly, gradation level [159], having a load of the sustain pulse that is relatively smaller, is displayed brighter than gradation level [160], causing reverse gradation.

When an image has a colored area where the color is bright and changes gradually and smoothly, the original color in the area may be displayed inaccurately if lines corresponding to the red (R), green (G) and blue colors have different loads, respectively.

### SUMMARY OF THE INVENTION

Accordingly, it is an aspect of the present invention to provide a display apparatus and a control method thereof to prevent inaccurate displays of gradation levels due to a load of the pixels in each line.

The foregoing and/or other aspects of the present invention are also achieved by providing a display apparatus processing an image frame divided into a plurality of subfields based on time, wherein the display apparatus comprises a motion detector detecting whether an input image is a still picture; a gradation level converter converting a brightness level of the input image into one of the gradation levels among a predetermined gradation level group for the still picture if the motion detector detects no motion in the input image, the gradation level group for the still picture being formed with gradation levels having no more than a predetermined reference number of subfields which are different in a state of luminance with respect to the corresponding subfields in adjacent gradation levels.

According to another embodiment consistent with the present invention, a display apparatus, processing an image frame divided into a plurality of subfields based on time, comprises a pixel detector detecting a pixel sharing a common gradation level in an input image; and a gradation level converter converting a brightness level of the input image into a gradation level having no more than a predetermined reference number of subfields which are different in a state of luminance with respect to the corresponding subfields in the common gradation level if the number of detected pixels sharing the common gradation level is more than a predetermined reference number of pixels.

According to still another embodiment consistent with the present invention, the display apparatus further comprises a motion detector detecting whether the input image is a still picture, wherein the gradation level converter converts the brightness level of the input image into the gradation level having no more than the predetermined reference number of subfields which are different in the state of luminance with respect to the corresponding subfields in the common gradation level if the number of detected pixels sharing the common gradation level is more than the predetermined reference number of pixels and the motion detector detects no motion in the input image.

According to still another embodiment consistent with the present invention, the display apparatus further comprises a display displaying an image thereon, the pixel detector detecting the pixel in the lines forming the display, the gradation level converter comparing a brightness level of the pixels forming the lines of the display containing more than the predetermined reference number of pixels sharing the common gradation level with the common gradation level, and converting the brightness level into a gradation level having no more than the predetermined reference number of subfields which are different in a state of luminance with respect to the corresponding subfields in the common gradation levels.

According to another embodiment consistent with the present invention, a display apparatus, processing an image frame divided into a plurality of subfields based on time, comprises a gradation level converter converting a brightness level of an input image into one of the gradation levels among an image gradation level group formed with gradation levels having not more than a predetermined reference number of subfields which are different in a state of luminance with respect to the corresponding subfields in adjacent gradation levels.

According to still another embodiment consistent with the present invention, the gradation level converter balances an error between the brightness level of the input image and the converted gradation level converted by the gradation level converter by applying an error diffusion method or a dithering method.

The foregoing and/or other aspects of the present invention are also achieved by a method of controlling a display apparatus processing an image frame divided into a plurality of subfields based on time, the method comprising detecting a pixel sharing a common gradation level in an input image; and converting a brightness level of the input image into a gradation level having no more than a predetermined reference number of subfields which are different in the state of luminance with respect to the corresponding subfields in the common gradation level if the number of detected pixels sharing the common gradation level in the input image is more than a predetermined reference number of pixels.

According to the foregoing aspect of the present invention, the method further comprises detecting whether the input image is a still picture, converting the brightness level of the input image being performed if the number of detected pixels sharing the common gradation level is more than the predetermined reference number of pixels and the input image is detected as a still picture.

The foregoing and/or other aspects of the present invention are also achieved by a method of controlling a display apparatus processing an image frame divided into a plurality of subfields based on time, the method comprising converting a brightness level of an input image into one of the gradation levels among an image gradation level group formed with gradation levels having no more than a predetermined reference number of subfields which are different in a state of luminance with respect to the corresponding subfields in adjacent gradation levels.

According to the foregoing aspect of the present invention, the method further comprises detecting whether the input image is a still picture, converting the brightness level of the input image being performed if the input image is detected as a still picture.

According to the foregoing aspect of the present invention, the method further comprises balancing an error between the brightness level of the input image and the converted gradation level converted by the gradation level converter by applying an error diffusion method or a dithering method.

### BRIEF DESCRIPTION OF THE DRAWINGS

The above and/or other aspects and advantages of the present invention will be readily apparent and appreciated from the following description of exemplary embodiments, taken in conjunction with the accompany drawings, of which:

FIG. 1 is a time configuration of a frame and subfields of a display panel of a plasma display panel (PDP);

FIG. 2A is a gradation level distribution explaining the difference in the load of the pixels for each subfield;

FIG. 2B shows a subfield codeword according to FIG. 2A;

FIG. 3 is a block diagram of a display apparatus according to a first embodiment of the present invention;

FIG. 4 illustrates a representable gradation level according to a combination of subfields and their luminance states, having a sustain pulse respectively weighted thereto;

FIG. 5 illustrates subfields codewords of available gradation levels forming a gradation level group for motion picture;

FIG. 6 is a block diagram of display apparatus according to a second embodiment of the present invention;

FIG. 7 is subfields codewords of the gradation level group for a motion picture adjusted to reduce a false contour in the motion picture; and

FIG. 8 is a block diagram of a display apparatus according to a third embodiment of the present invention.

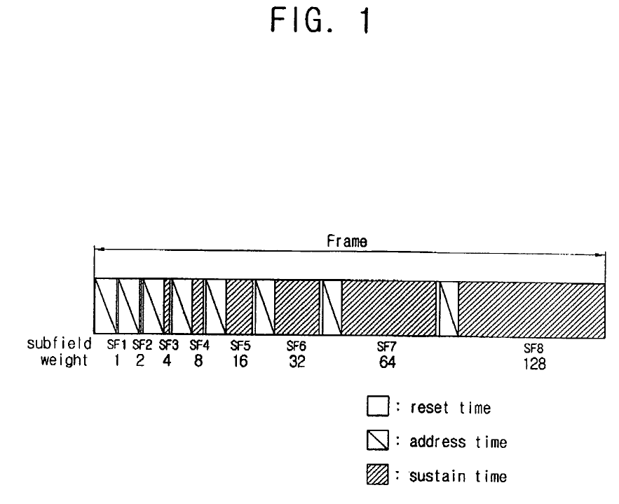

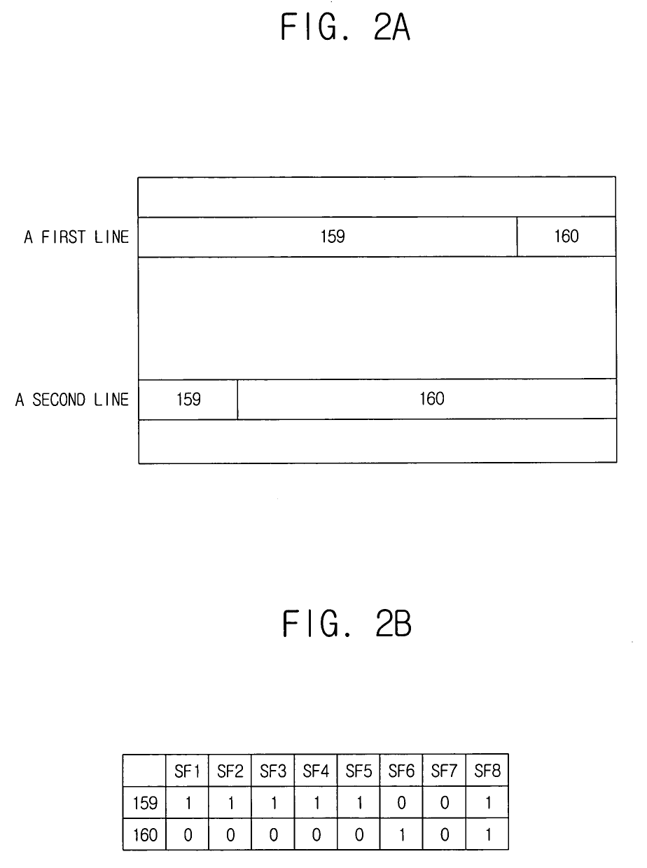

### DETAILED DESCRIPTION OF ILLUSTRATIVE NON-LIMITING EMBODIMENTS OF THE PRESENT INVENTION

Reference will now be made in detail to illustrative, non-limiting embodiments of the present invention, examples of which are illustrated in the accompanying drawings, wherein like reference numerals refer to like elements throughout. The exemplary embodiments are described below, with reference to the accompanying drawings, in order to explain the present invention.

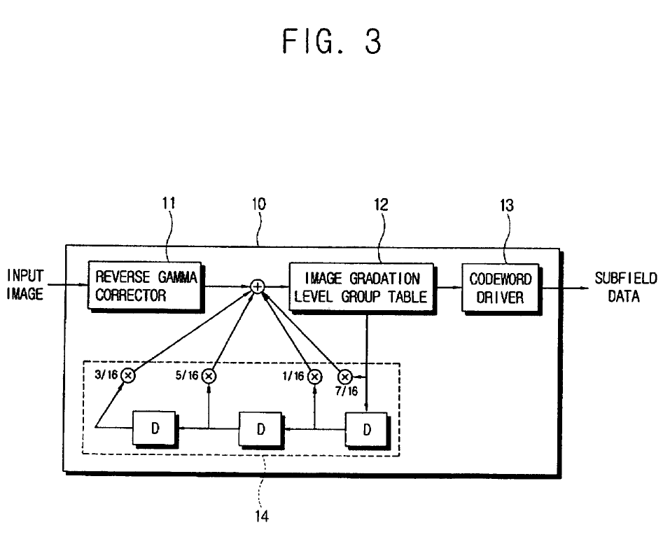

FIG. 3 is a block diagram of a display apparatus according to a first embodiment of the present invention. As shown therein, the display apparatus comprises a gradation converter 10. The gradation converter 10 converts an input image signal into one of the gradation levels among an image gradation level group and outputs the converted input image signal. The input image signal contains image data such as the brightness level of the pixels.

The image gradation level group is a collection of a plurality of gradation levels having no more than a predetermined reference number of subfields which are different in a luminescence state with respect to the corresponding subfields in adjacent gradation levels. Herein, the ‘different in a luminance state with respect to the corresponding subfields’ indicates that a bit shift has occurred in the corresponding subfield codewords. Hence, the image gradation level group is formed by gradation levels where the total number of bit shifts between the subfield codewords of adjacent gradation levels is not more than a predetermined reference number.

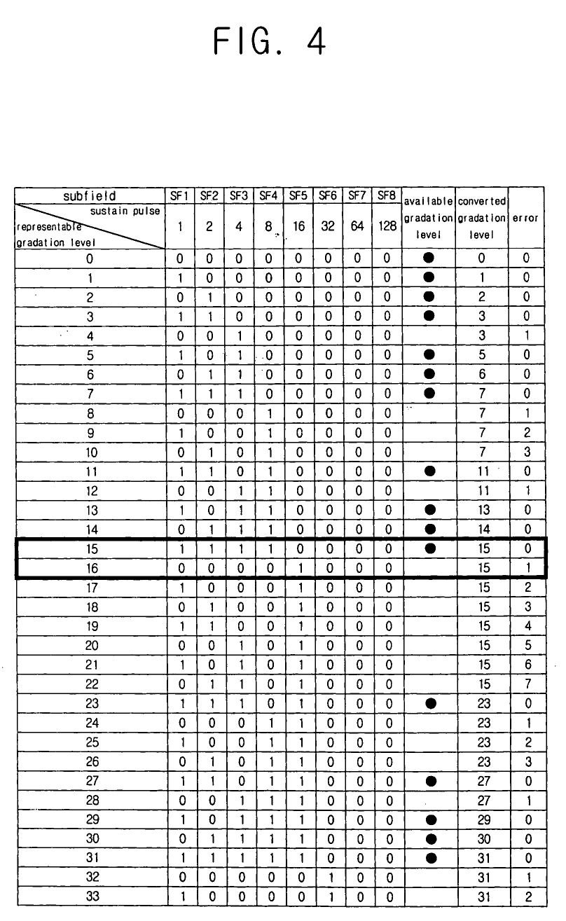

For example, referring to FIG. 4, a frame is divided into eight subfields based on time. The number of sustain pulses weighted to each of the subfields is limited to 2⁰ to 2ⁿ⁻¹, where n is 8 since one frame is divided into eight subfields. The combination of 8-bit codewords results in the total number of representable gradation levels being 256. For brevity, FIG. 4 only shows gradation levels [0] to [33], but the total number of representable gradation levels is [0] to [255].

The foregoing image gradation level group is a collection of representable gradation levels which have no more than two bits shifted when compared to the immediately preceding available gradation level. In other words, representable gradation levels [15] and [16] show that five bits are successively shifted from the first subfield to the fifth subfield. Therefore, representable gradation level [15], which has only one bit shifted from gradation level [14], is selected to be an available gradation level forming the image gradation level group, whereas representable gradation level [16], which has five bits shifted from gradation level [15], is selected to be an unavailable gradation level.

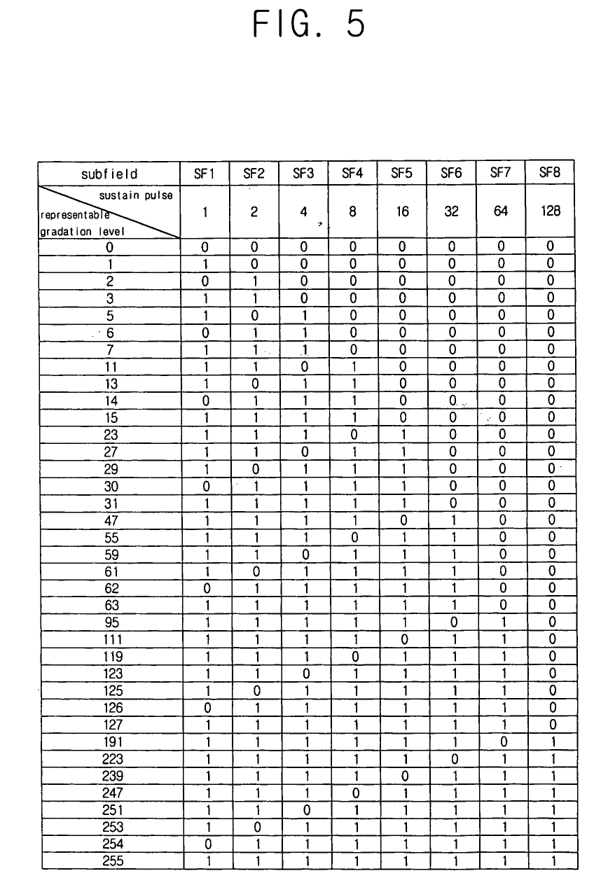

FIG. 5 illustrates the subfield codewords of the available gradation levels forming the image gradation level group. As shown therein, the total number of bit shifted between adjacent available gradation levels is limited to a predetermined reference number, which is one or two. The image gradation level group sets a limitation with respect to the total number of bit shifts between adjacent gradation levels in order to prevent inaccurate displays of gradation levels due to the load of each line.

Referring to FIG. 3, the gradation converter 10 may comprise a reverse gamma corrector 11, a table of an image gradation level group 12, a codeword driver 13 and an error diffusing part 14.

The reverse gamma corrector 11 converts an input image signal on the basis of the following Equation (1).
Y=X^{2.2} Equation (1)
(where “X” is the input video signal and “Y” is the output signal)

If the input signal and the output signal are respectively represented as 8-bit data, the brightness levels of the input/output image signals are represented as 6-bit integer, and the right side of the decimal point indicates an error represented as 2-bit data. The output signal of the reverse gamma corrector 11 is added with the error of an adjacent pixel and inputted to an image gradation level group table 12.

The image gradation level group table 12 stores the gradation levels selected as the image gradation level group, and converts the input video signal into one of the stored gradation levels among the image gradation level group. In other words, referring to FIG. 4, the image gradation level group table 12 converts the input video signal having the brightness level corresponding to gradation level [18] into available gradation level [15].

The converted gradation level [15] is inputted to the codeword driver 13, and the corresponding subfield codeword is transmitted to the display panel as information about the corresponding subfield. That is, the subfield codeword is transmitted to the display panel as 8-bit data for each pixel during the address time, and accordingly, the pixel is selected to be emitted during the sustain period.

Meanwhile, input gradation level [18] is converted into output gradation level [15] resulting in a conversion error of 3, which is inputted to the error diffusing part 14. The error diffusing part 14 diffuses the error, between the gradation level inputted to the image gradation level table 12 and the converted gradation level, to the adjacent pixel. The diffused error is weighted by a proper value according to a position of the pixel and added to the image information of the adjacent pixel. Accordingly, the error diffusing part 14 comprises a sustaining part sustaining the error per line, pixel or clock; a multiplier multiplying the weighted value; and an adder adding the weighted value to the image information of the adjacent pixel.

The error diffusing part 14 partially maintains the average brightness level by diffusing the error generated due to the conversion between the gradation levels to the adjacent pixels. This error diffusing method may be replaced with a dithering method.

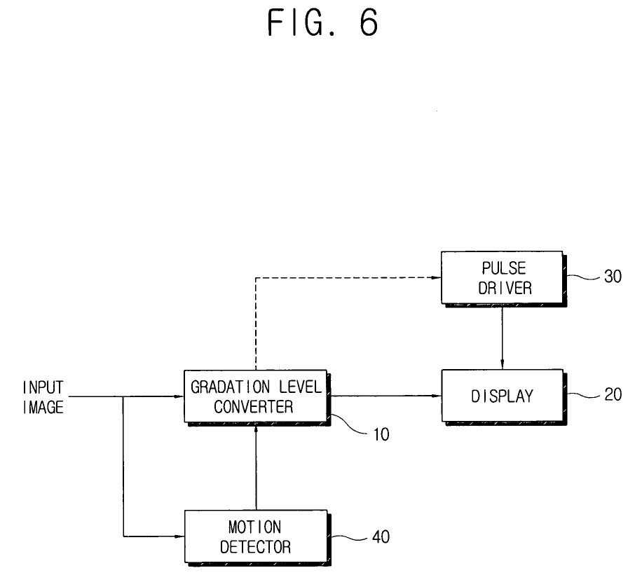

FIG. 6 is a block diagram of a display apparatus according to a second embodiment of the present invention. As shown therein, the display apparatus comprises a gradation level converter 10, a display 20, a pulse driver 30 and a motion detector 40.

The gradation level converter 10 displays an image by converting an input image into a proper gradation level and outputting the converted input image to the display 20. The pulse driver 30 supplies, on a time basis, the sustain pulse weighted to each of the subfields to the display 20.

The motion detector 40 detects whether the input image is a still picture. As examples of detecting methods, there are a couple of methods that may be applied: a motion estimation detecting a motion vector between a former frame and a current frame per regular sized blocks, and a motion detection tracking the shift of an image using the value of the pixels

The detected result of the motion detector 40 is outputted to the gradation level converter 10. If the motion detector 40 detects no motion in the input image, the gradation level converter 10 converts the brightness level of the input image into a gradation level among a group of gradation levels for a still picture.

The group of gradation levels for the still picture comprises the same gradation levels as the image gradation level group in the first embodiment of the present invention. However, if a gradation level defined as an ‘unavailable gradation level’ is set to the available gradation level, the adjacent available gradation levels are no longer available gradation levels. In other words, the gradation levels in the image gradation level group are changed. For example, if the gradation level [4] in FIG. 4 is set as an available gradation level, the adjacent gradation level [3] is no longer an available gradation level, and thus, available gradation levels [2] and [5] are now adjacent to the available gradation [4]. Accordingly, the image gradation level group can be formed with various constitutions of gradation levels.

Meanwhile, if the motion detector 40 detects the input image as a moving picture, the gradation level converter 10 converts the brightness level of the input image into a gradation level among a group of moving picture gradation levels. The moving picture gradation level group is a collection of gradation levels which efficiently reduce a false contour in the motion picture.

A false contour generally occurs when a gradation difference between a motion area and an adjacent area gradually accumulates and forms an afterimage around the motion area. Thus, the image gradation level group is applied to prevent the gradation level difference between the motion area and the adjacent area from accumulating gradually, and thereby, reduces the false contour of the motion picture.

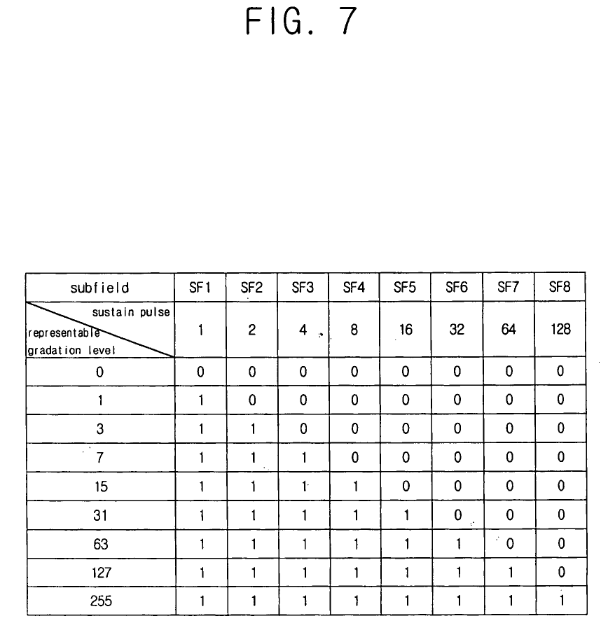

FIG. 7 shows subfield codewords of the motion picture gradation level group.

As shown therein, each of the codewords has one bit shifted between adjacent gradation levels. This motion picture gradation level group has a limited number of gradation levels to represent brightness realizing decreased brightness while efficiently reducing the false contour of the motion picture.

On the other hand, a conventional still image gradation level group does not generate the false contour with respect to the still image, and thus, as many gradation levels as possible can be applied to enhance the brightness. In other words, the conventional still image gradation level group uses all the representable gradation levels in the gradation level table in FIG. 4 as available gradation levels.

However, the still image gradation level group according to the second embodiment of the present invention has gradation levels having no more than a limited number of subfields which are different in a state of luminance with respect to the corresponding subfields in adjacent gradation levels. The number of subfields whose corresponding luminescent states are different can be adjusted by a user as necessary, and preferably, but not necessarily, adjusted in consideration of the number of gradation levels applied to reproduce the brightness, as well as decreasing the gradation effect, in accordance with the load of the lines.

A second embodiment of the present invention relates to the gradation level group for the moving picture. FIG. 7 illustrates an example of a gradation level group for a moving picture having one bit shifted between corresponding subfields of adjacent gradation levels, and FIG. 5 illustrates an example of a gradation level group for a still image having no more than 2 bit shifted between corresponding subfields of adjacent gradation levels.

To summarize an operation of the display apparatus illustrated in FIG. 6, the motion detector 40 detects whether the input image is a still image and outputs the detected result to the gradation level converter 10. Based on the detected result, the gradation level converter 10 converts the brightness level of the input image into a gradation level belonging to the gradation level group for a motion picture or the gradation level group for a still picture, and the gradation level converter 10 outputs the converted input image to the display 20. The display 20 displays the input image in accordance with the subfield codeword outputted from the gradation level converter 10 and the sustain pulse outputted from the pulse driver 30 thereon. However, the sustain pulse outputted from the pulse driver 30 for each of the subfields is respectively weighted, and the number of the sustain pulses weighted to each of the subfields can be adjusted according to an average picture level (APL) of a detectable input image by the gradation level converter 10. In addition, the gradation level converter 10 according to the second embodiment of the present invention may balance the error between the input image and the converted gradation level by diffusing the error to the adjacent pixel based on the error diffusion method or the dithering method.

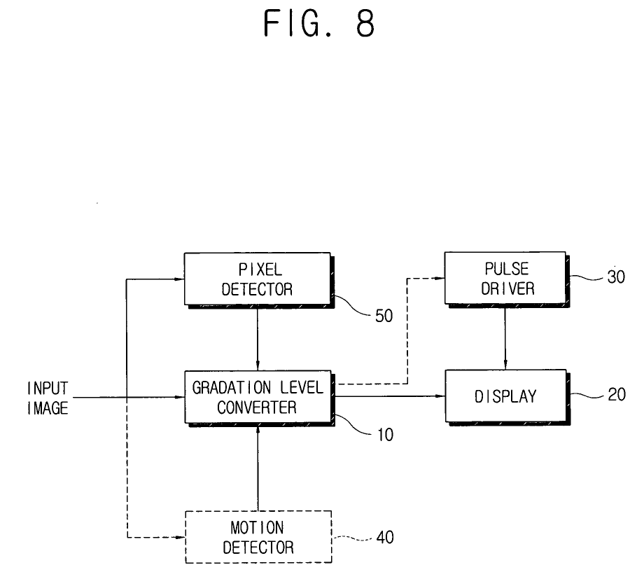

FIG. 8 is a block diagram of a display apparatus according to a third embodiment of the present invention.

As shown therein, the display apparatus comprises a gradation level converter 10, a display 20 and a pixel detector 50.

The gradation level converter 10 converts an input image into a proper gradation level, and outputs it to the display 20 to display an image thereon. The pulse driver 30 transmits, on time basis, the sustain pulse weighted to each of the subfields to the display 20.

The pixel detector 50 detects pixels sharing a common gradation level from the input image, and outputs a detecting result to the gradation level converter 10. It is preferred, but not necessary, that the pixel detector 50 detects the pixels sharing the common gradation level for a given area or line in which the sustain pulses are commonly driven.

If the total number of pixels sharing the common gradation level is more than a predetermined reference number of pixels, the gradation level converter 10 compares the brightness level of the input image with the common gradation level and converts the brightness level of the input image into a gradation level having no more than the predetermined reference number of subfields that are different in a state of luminance with respect to the corresponding subfields in the common gradation levels.

In other words, as described in the foregoing embodiments, the configuration of the gradation levels changes based on a reference gradation level that determines the gradation level group for a motion picture and the gradation level group for a still picture. For example, in FIG. 4, if gradation level [4] is set as the reference gradation level and adjacent gradation levels having no more than 2 bits shifted are selected to form a new gradation level group, it is obvious that the new gradation level group will be different from the gradation level group illustrated in FIG. 5.

Thus, according to the third embodiment of the present invention, the gradation level group of the gradation level converter 10 is flexibly configured as compared with the table shown in FIG. 5. That is, the gradation level converter 10 converts the brightness level of the input image into one of the gradation levels among the newly formed gradation level group for the image using the common gradation levels detected from the pixel detector 50.

This gradation level change may be applied through a whole frame, but more preferably applied to the area or the line in which the pixel was detected.

In addition, in consideration of the false contour in the motion picture, it is preferable, but not necessary, that the gradation level converter 10 performs the foregoing gradation level conversion to a still picture. Therefore, as shown in FIG. 8, the display apparatus preferably further comprises the motion detector 40 detecting whether the input image is a motion picture or a still picture.

The detected result of the motion detector 40 is outputted to the gradation level converter 10, and the gradation level converter 10 converts the input image into a proper gradation level according to the detected results of the motion detector 40 and the pixel detector 50.

In other words, if the motion detector 40 detects motion in the input image, the gradation level converter 10 converts the brightness level of the input image into one of the gradation levels in the group for a motion picture illustrated in FIG. 7.

On the other hand, if the motion detector 40 detects no motion in the input image, the gradation level converter 10 applies the multi-gradation level group formed with the ‘representable gradation levels’ in FIG. 4 to accurately express the brightness level of the input image.

If the input image is detected as the still picture by the motion detector 40 and the number of pixels sharing the common gradation levels is detected, by the pixel detector 50, to be more than the predetermined reference number of pixels, the gradation level converter 10 converts the brightness level of the input image into a gradation level having no more than the predetermined reference number of subfields which are different in the state of luminance with respect to the corresponding subfields in the common gradation level.

According to the third embodiment of the present invention, the load of a line will not cause a decrease in brightness which is expressed by the gradation levels and the load independent pixels of the image may be accurately displayed.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus processing an image frame divided into a plurality of subfields based on time, comprising:
a motion detector detecting whether an input image is a still picture; and
a gradation level converter converting a brightness level of the input image into one of a plurality of gradation levels in a gradation level group for the still picture if the motion detector detects no motion in the input image,
wherein the gradation level group for the still picture is formed with gradation levels having no more than a predetermined reference number of subfields which are different in a state of luminance with respect to corresponding subfields in adjacent gradation levels.

2. A display apparatus processing an image frame divided into a plurality of subfields based on time, comprising:
a pixel detector detecting a pixel sharing a common gradation level in an input image; and
a gradation level converter converting a brightness level of the input image into a gradation level having no more than a predetermined reference number of subfields which are different in a state of luminance with respect to corresponding subfields in the common gradation level,
wherein the gradation level converter converts the brightness level if a number of the detected pixels sharing the common gradation level is more than a predetermined reference number of pixels.

3. The display apparatus according to claim 2, further comprising:
a motion detector detecting whether the input image is a still picture,
wherein the gradation level converter converts the brightness level if the number of the detected pixels sharing the common gradation level is more than the predetermined reference number of pixels and the motion detector detects no motion in the input image.

4. The display apparatus according to claim 2, further comprising:
a display displaying an image thereon,
wherein the pixel detector detects the pixel in lines forming the display, and
wherein the gradation level converter compares a brightness level of pixels forming the lines of the display containing more than the predetermined reference number of pixels sharing the common gradation level with the common gradation level, and converts the brightness level into a gradation level having no more than the predetermined reference number of subfields which are different in the state of luminance with respect to the corresponding subfields in the common gradation levels.

5. A display apparatus processing an image frame divided into a plurality of subfields based on time, comprising:
a gradation level converter converting a brightness level of an input image into one of a plurality of gradation levels among an image gradation level group formed with gradation levels having no more than a predetermined reference number of subfields which are different in a state of luminance with respect to corresponding subfields in adjacent gradation levels.

6. The display apparatus according to claim 1, wherein the gradation level converter balances an error between the brightness level of the input image and the converted gradation level converted by the gradation level converter by applying one of an error diffusion method and a dithering method.

7. The display apparatus according to claim 2, wherein the gradation level converter balances an error between the brightness level of the input image and the converted gradation level converted by the gradation level converter by applying one of an error diffusion method and a dithering method.

8. The display apparatus according to claim 5, wherein the gradation level converter balances an error between the brightness level of the input image and the converted gradation level converted by the gradation level converter by applying one of an error diffusion method and a dithering method.

9. A method of controlling a display apparatus processing an image frame divided into a plurality of subfields based on time, comprising:
detecting a pixel sharing a common gradation level in an input image; and
converting a brightness level of the input image into a gradation level having no more than a predetermined reference number of subfields which are different in a state of luminance with respect to corresponding subfields in the common gradation level,
wherein the converting the brightness level of the input image is performed if a number of the detected pixels sharing the common gradation level in the input image is more than a predetermined reference number of pixels.

10. The method according to claim 9, further comprising:
detecting whether the input image is a still picture,
wherein the converting the brightness level of the input image is performed if the number of the detected pixels sharing the common gradation level is more than the predetermined reference number of pixels and the input image is detected as the still picture.

11. A method of controlling a display apparatus processing an image frame divided into a plurality of subfields based on time, comprising:
converting a brightness level of an input image into one of a plurality of gradation levels among an image gradation level group formed with gradation levels having no more than a predetermined reference number of subfields which are different in a state of luminance with respect to corresponding subfields in adjacent gradation levels.

12. The method according to claim 11, further comprising detecting whether the input image is a still picture,
wherein the converting the brightness level of the input image is performed if the input image is detected as the still picture.

13. The method according to claim 9, further comprising:
balancing an error between the brightness level of the input image and the converted gradation level converted by the gradation level converter by applying one of an error diffusion method and a dithering method.

14. The method according to claim 11, further comprising:
balancing an error between the brightness level of the input image and the converted gradation level converted by the gradation level converter by applying one of an error diffusion method and a dithering method.
